(19) United States
(12) Patent Application Publication
(10) Pub. No.: US 2024/0219074 A1
(43) Pub. Date: Jul. 4, 2024

(54) System Comprising an Installation Having a Heating System and Device or Component, and Method for Determining Energy Consumption of the System

(71) Applicant: Siemens Aktiengesellschaft, Muenchen (DE)

(72) Inventor: Robert FRELLER, Lauf (DE)

(21) Appl. No.: 18/684,067

(22) PCT Filed: May 17, 2022
(86) PCT No.: PCT/EP2022/063326

§ 371 Date: Feb. 15, 2024

(30) Foreign Application Priority Data
Aug. 16, 2021 (EP) 21191436

(51) Int. Cl. F24H 15/148; G01M 99/00

(52) U.S. Cl. CPC F24H 15/148; G01M 99/002

(57) ABSTRACT

A system includes an installation that has a heating system and a device or component, wherein the system is configured to heat the device or component via a heated medium transported within the heating system, where the heating system includes a supply system within which the heated medium is supplied to the device or component, where the supply system includes at least one supply-system sensor, the heating system includes a removal system for the medium, the removal system includes at least one removal-system sensor, and where the system includes a computer device that is configured to simulate the heating system using data from the at least one supply-system sensor and/or the at least one removal-system sensor, where the computer device is configured to ascertain energy-flow information.

### CROSS-REFERENCE TO RELATED APPLICATIONS

This is a U.S. national stage of application No. PCT/EP2022/063326 filed 17 May 2022. Priority is claimed on European Application No. 21191436.1 filed 16 Aug. 2021, the content of which is incorporated herein by reference in its entirety.

### BACKGROUND OF THE INVENTION

### 1. Field of the Invention

The present invention relates to a system comprising an installation having a heating system and a device or component, and to a method for determining the energy consumption of the installation, where the system is configured to heat the device or component via a heated medium transported within the heating system, in particular via heated water or steam, where the heating system comprises a supply system within which the heated medium is supplied to the device or component, where the supply system comprises at least one supply system sensor, where the heating system comprises a discharge system within which the medium is discharged from the device or component, and where the discharge system comprises at least one discharge system sensor.

### 2. Description of the Related Art

EP 0 569 837 B1 discloses an exemplary device for measuring the efficiency of a steam heater, where the steam heater comprises a steam flow-rate sensor for measuring the flow rate of the steam flowing into the device, a steam pressure gauge for measuring the pressure of the steam flowing into the device, and a temperature gauge for measuring the temperature of the steam. The heat transfer efficiency of the steam heater is calculated from the temperature of the material to be heated and the amount of heat that flows into the steam heater.

It is a disadvantage of the prior art that the measurement of the thermal efficiency of a steam heater requires relatively complex equipment. Flow-rate sensors in particular are relatively expensive and increase the costs and equipment complexity of such a device disproportionately. In particular, if the measurement of such a heating and/or heat transfer efficiency does not need to be constantly observed during operation, but, for example, only needs to be checked at regular intervals, for example, on an initial setup of a corresponding device or reparameterization of such a device, then the cost-benefit ratio of such sensors is relatively poor.

### SUMMARY OF THE INVENTION

In view of the foregoing, it is therefore an object of the present invention to provide a method or a device which enables a simpler, less elaborate and/or more cost-effective measurement of the thermal efficiency of a steam heater.

This and other objects and advantages are achieved in accordance with the invention by a system comprising an installation, where the installation further comprises a heating system as well as a device or component.

The system is configured to heat the device or component via a heated medium transported within the heating system, in particular via heated water or steam.

The heating system comprises a supply system, within which the heated medium is supplied to the device or component, where the supply system comprises at least one supply system sensor.

The heating system also comprises a discharge system, within which the medium is discharged from the device or component, where the discharge system comprises at least one discharge system sensor.

The system comprises a computer device that is configured to simulate the heating system using data from the at least one supply system sensor and/or the at least one discharge system sensor, where the computer device is furthermore configured to ascertain energy inflow information, energy outflow information and/or energy consumption information.

Because the system comprises a computer device that is configured for simulating the heating system, it is possible to simulate the behavior of the heating system, in particular in interaction with the device or component, in parallel with a process actually running in the heating system or installation. By extracting appropriate quantities that are or can be ascertained during the simulation, for example, a quantity of steam flowing through a certain pipe cross-section of the heating system, an associated temperature and, if applicable, an associated pressure, it is possible to determine the energy flow or energy stream of a vapor flowing in the heating system without the need to install appropriate sensor hardware in the installation. This simplifies the measurement energy consumption, energy efficiency and/or energy flow in such a heating system and/or makes a corresponding determination of such quantities more cost-effective.

Here, the system is configured to heat the device or component via the heating system and comprises the essential components necessary for this, in particular the installation, consisting of the device or component and the heating system. Furthermore, the system can comprise a control device for controlling the device or component and/or the heating system. Furthermore, the system also comprises the computer device for simulating the heating system and for ascertaining the energy inflow information, the energy outflow information and/or the energy consumption information.

The device can be any type of machine, installation or assembly. The component can be, for example, an assembly of a larger installation or device or may also be an independently acting component. A component may be configured, for example, as a mechanically contiguous assembly or device.

The heating system is configured to transport the heated medium to the device or component, for transporting the medium away from the component, and for heating the medium and feeding the heated medium into the supply region.

The heating system can be configured, for example, as a circuit system or comprise such a circuit system. In such a circuit system, for example, a media heating unit may be provided, which heats the heated medium used for heating the device or component and feeds it at, for example, a predetermined temperature and a predetermined or predeterminable pressure into a corresponding piping system of the heating system, for example, the supply system. Furthermore, the circuit system can then be configured such that the medium discharged from the device or component in the discharge system is completely or partially fed back to the media heating unit. This recirculation of the discharged medium can, for example, at least partially occur via the discharge system.

The medium used in the heating system can be any liquid or gas suitable for heating and being transported to the device or component. In particular, the gas can be steam or nitrogen, for example. For example, the liquid may be water. It may be necessary that a certain pressure or pressure range and/or a certain temperature or temperature range must be or is present in the heating system to transport the gas or liquid.

The supply system comprises, for example, all components that are or must be necessary, required and/or advantageously present for transporting the heated medium to the device or component. For example, these can be appropriate media sources, pipelines, hoses, pumps, valves, sensors, vessels, premises, flanges, coupling pieces, gaskets and/or similar components or parts. Such components or parts or their junctions must be configured for the temperatures and pressures present within the heating system.

In cases in which a heating system is formed as a circuit system and/or comprises a corresponding media heating device for heating the medium, the media heating device or the central media heating component can also be attributed to the supply system.

The discharge system comprises, for example, all components that are or must be necessary, required and/or advantageously present for transporting the heated medium away from the device or component. For example, these can be appropriate media sinks, outflows or outlets, pipelines, hoses, pumps, valves, sensors, vessels, premises, flanges, coupling pieces, gaskets and/or similar components or parts. Such components or parts or their junctions must be configured for the temperatures and pressures present within the heating system.

In cases in which a heating system is formed as a circuit system or comprises a corresponding extraction device, a central heating device of the heating system, to which media discharged from the device or component are fed back, can also be associated with the discharge system. Here, such a central heating device of the heating system can be attributed to both the supply system and the discharge system. A corresponding extraction device can also be attributed to the extraction system.

The at least one supply system sensor is configured, for example, such that a simulation of a media stream in at least one region of the supply system, multiple regions of the supply system or even all regions of the supply system is possible based on appropriate sensor data.

The at least one discharge system sensor is configured, for example, such that a simulation of a media stream in at least one region of the supply system, multiple regions of the discharge system or even all regions of the discharge system, is possible based on appropriate sensor data.

The at least one supply system sensor and/or the at least one discharge system sensor can be configured, for example, as a temperature, pressure and/or valve position sensor, where a valve position can also be determined indirectly via a valve controller. This is also understood as a valve position sensor within this description.

Furthermore, the at least one supply system sensor and/or the at least one discharge system sensor can each be configured, for example, as a mass-flow, flow-rate and/or energy flow sensor. However, sensors such as these tend to be rarely used in such heating systems, because they are comparatively expensive and are often not absolutely necessary for appropriate functional control and/or regulation of the heating system.

The computer device can be any computer device that has sufficient storage and processing capacity to handle the simulation of the heating system and the determination of energy inflow information and/or energy outflow information and/or energy consumption information. In particular, the computer device can be, for example, a PC, a workstation, a computer network, a cloud, a control device, a controller, a programmable logic controller, a modular programmable logic controller, or a similar device. Furthermore, the computer device can be configured, for example, as an edge device. The computer device may also be a piece of computer hardware, a computer or else part of a computer network, or also, for example, an application in a cloud or else in a computer network or a corresponding server or processing device.

For example, the computer device may be a control device or a control computer (or a part or module thereof) that at least controls and/or regulates the heating system, among other tasks. Furthermore, the computer device may also be configured as an edge device linked to such a control device or control computer.

A computer device may also be configured, for example, as a virtual computer device instance, which executes or can be executed, for example, corresponding on hardware, a corresponding computer network or a cloud. The functionality of the computer device in this case is generated during the execution of the virtual computer device instance, e.g., on the hardware mentioned.

The computer device may also be composed of multiple sub-devices. These can be communicatively coupled, for example. Here, each of the sub-devices can then in turn be configured in accordance with the above-described embodiments for a computer device.

The computer device can be further configured such that the data supplied to it from the at least one supply system sensor and/or the at least one discharge system sensor is used directly or indirectly as an input variable to ascertain energy inflow information and/or energy outflow information and/or energy consumption information. Thus, for example, with data from the at least one supply system sensor an energy inflow value can be ascertained and, for example, via data from the at least one discharge system sensor an energy outflow value can be ascertained and, by calculating the difference between the energy inflow value and the energy outflow value, an energy consumption value can be ascertained.

Furthermore, the computer device can be configured to process or further process the data supplied to it from the at least one supply system sensor and/or the at least one discharge system sensor. Such processing or further processing may include, for example, normalization, conversion, transformation, reformatting, translation, and/or any other comparable processing step.

Here, the computer device may be configured such that, after processing or post-processing of the data supplied to it from the at least one supply system sensor and/or the at least one discharge system sensor, one or more results of such processing or post-processing is/are used directly or indirectly to ascertain energy inflow information and/or energy outflow information and/or energy consumption information as an input variable.

The computer device may further comprise, for example, a simulation environment and/or a digital twin, which are or can be configured to run a simulation program for simulating a system in accordance with the disclosure, an installation in accordance with the present disclosure and/or a heating system and/or a component in accordance with the present disclosure. The computer device may also comprise, for example, a simulation environment with a simulation program for simulating a system according to the present description, an installation in accordance with the present disclosure and/or a heating system and/or a component in accordance with the present disclosure.

The computer device may also be configured for the transmission, transfer and/or output of information regarding the energy inflow information and/or energy outflow information and/or energy consumption information to a further data processing device. Such a data processing device may be, for example, an operator input-output device (an “HMI” (human machine interface)), a control device, for example, for controlling the installation and/or the heating system, an edge device, a cloud or other data processing device, for example, for storage, output, archiving or similar.

The information regarding the energy inflow information and/or energy outflow information and/or energy consumption information can comprise, for example, an energy inflow, energy outflow or energy consumption value. Furthermore, the information mentioned may also be or comprise information evaluating the information, such as a warning message or a notification that, for example, values ascertained are within certain specifications, or similar information.

The simulation of the heating system can be configured such that, for example, a piping system of the heating system with corresponding pipe lengths or hose lengths and cross-sections, valves, sensors, heat transfers (for example, to the device or component), as far as the output of the heating system, for example, a return line to a central heating system or other media output, is simulated. The input variables for such a simulation can be provided, for example, by at least one pressure and/or at least one temperature of the heated medium at an input region of the heating system, for example, an output of a corresponding media heating system, or comparable process parameters. Furthermore, data from additional sensors and component data within the heating system, for example, valve positions, temperatures and/or pressures at other points within the heating system, also temperatures on, for example, the device or component to be heated, as well as in the discharge region of the heating system, can be used to simulate the heating system, or also other process parameters. As a rule, the greater the number of such sensors in the real system to be simulated are used as input variables for simulating the system, the higher the quality and accuracy of the simulation of the heating system.

Furthermore, the simulation of the heating system can be configured such that, for example, at different points of the heating system, a temperature, a pressure, a flow velocity, an energy flow and/or further process parameters of the medium and/or the heating system itself is determined or can be determined as part of the simulation. The simulation of the heating system can also be configured such that these data items are or can be ascertained, for example, at all essential points or in all essential regions or in all regions of the heating system.

The simulation of the heating system may be further configured such that the simulation is or can be implemented in parallel with a real process or process sequence running within the heating system and/or the device or component, i.e., that the simulation of the heating system essentially simulates or calculates the current conditions within the heating system and/or the device or component at each point in time. In this way, for example, the simulation can also be used to acquire variables, measured values and/or states within the heating system and/or the device or component that are either impossible, difficult or relatively time-consuming to acquire in the real installation, because, for example, there are no sensors at the appropriate locations, or no sensors can be installed or no suitable sensor technology exists for corresponding measured variables, or a corresponding sensor system would be too expensive or would be too complicated to install.

The acquisition of such process parameters in the context of a simulation performed in parallel with a process is also referred to, e.g., as virtual sensor technology. A corresponding acquisition of a specific process parameter in the context of such a simulation is then referred to, for example, as a “virtual sensor” for this process parameter, or also as a soft sensor for this process parameter.

By using such a simulation running/executing in parallel with the real conditions in the heating system or the device or component, it is possible to monitor the heating system in operation better, more accurately and/or more flexibly with reduced technical effort. For example, sensor values can be simulated or ascertained flexibly at different points in the heating system within the simulation without having to install corresponding sensors at these locations in the real system.

This also simplifies and facilitates, for example, troubleshooting of faults within the heating system, because ascertaining a wide range of process parameters in the heating system at many different points offers a comparatively simple means of troubleshooting, or searching for causes of such faults, more simply and/or easily.

The energy inflow information may be or comprise, for example, any information characterized by the energy flowing through a particular section of the supply system. For example, the section of the supply system can be a conduit, pipe, and/or hose cross-section within the supply system. The information may be, for example, a volume of media flowing through such a section per unit time, an energy or amount of energy per unit of time, a temperature and/or pressure of a medium flowing through such a section, one or more physical measurement variables that describe an energy flow or matter or media flow, or comparable information.

Thus, energy inflow information can be or comprise, for example, media flow information with respect to the medium flowing through a particular section per unit time plus, for example, a temperature and or a pressure of this medium. Furthermore, the energy inflow information may also directly comprise one or more physical quantities that characterize or describe energy flowing through a section per unit time. The energy of the heated medium can be specified, for example, as an absolute energy value or in relation to the energy of an unheated medium and/or the energy, for example, of a medium fed back by the device or component, such as in the discharge system.

The energy outflow information may be formed and configured, for example, in the same form as the energy inflow information and be or comprise, for example, any information that is characterized by an energy flowing through a certain section of the discharge system, for example.

The energy consumption information may be formed and configured, for example, as information regarding a difference between the media energy supplied via the heating system of the device or component, for example, via the supply system, and the media energy discharged from the device or component, for example, via the discharge system. Here, such information can be formed and configured, for example, as a physical quantity expressed as a difference between a quantity of energy supplied and a quantity of energy discharged, or else as a difference between an energy stream supplied or a corresponding heat output and an energy stream discharged or a corresponding heat output.

Here, heat output is understood to mean heat energy measured per unit time.

Furthermore, the energy inflow, the energy outflow and/or the energy consumption information may also each include qualitative or evaluating information or also meta-information.

Qualitative or evaluating information may include, for example, information on whether a specific energy flow or energy consumption is within an expected range or higher or lower. Qualitative information such as this can then be output, for example, at least inter alia via the computer device, to a user or an HMI, to facilitate, for example, monitoring of the heating system.

Meta-information relating to the energy information transferred in each case may be, for example, further physical state variables within the heating system, information regarding an operating state of the heating system and/or the device or component and/or a heating device for the heating medium, or comparable information. Furthermore, meta-information can also be, for example, information relating to the device or component used or also to the heating system.

The computer device may be configured for output or communication of the energy inflow information, the energy outflow information and/or the energy consumption information, for example to an HMI, a user, a further data processing device, a database, a control device (e.g., for the heating system and/or the installation and/or the device or component), or comparable devices. Here, for example, such an output or communication may be intended for output to a user, for archiving, for controlling the heating system and/or the device or component or the installation, or similar purposes. In an advantageous embodiment, the heating system does not comprise an energy flow sensor or comparable sensor for measuring an energy flow or energy stream caused by a media flow passed through the heating system. Furthermore, the heating system does not comprise a flow-rate sensor or comparable sensor for measuring a media flow passed through the heating system.

In a further advantageous embodiment, the at least one supply system sensor comprises a supply temperature sensor and/or a supply pressure sensor and the at least one discharge system sensor comprises a discharge pressure sensor, where the computer device is configured to ascertain the energy inflow information and/or the energy outflow information and/or the energy consumption information using data of the supply temperature sensor, the supply pressure sensor and/or the discharge pressure sensor.

As part of this embodiment, a simulation of the heating system is performed by the computer device using a supply temperature sensor and/or a supply pressure sensor and a discharge pressure sensor. In the context of theses simulations, for example, the energy inflow information, the energy outflow information and/or the energy consumption information can then be determined by determining corresponding physical quantities via the simulation.

In a further advantageous embodiment, for example, the heating system is simulated via one or more supply temperature sensors and one or more supply pressure sensors and one or more discharge pressure sensors as input parameters for the simulation. Based on this simulation, the computer device can then determine and, if appropriate, output, for example, energy inflow information according to the present description, energy outflow information according to the present description and/or energy consumption information according to the present description.

This embodiment has the advantage that comparatively little sensor technology must be physically provided in the heating system to ascertain the corresponding information. Furthermore, in particular the temperature and pressure sensors are usually included in the sensors that are necessary as standard for the operation of such a heating system anyway and must be provided for normal operation anyway.

Therefore, this embodiment further allows a simpler, less complex and/or less expensive measurement of a thermal efficiency of the heating system and/or the installation.

The computer device may also comprise a digital twin of the installation or the heating system and/or can be configured for simulating the installation or the heating system.

This embodiment enables, for example, the computer device, for example, in addition to the simulation of the heating system, to also simulate the entire installation, which means in particular that the effects of the device or component on the energy balance in the heating of the device or component via the heating system can be better taken into account.

The use of a digital twin in a system as described in this disclosure further allows access to a large amount of data, parameters and characteristic values relating to the installation or heating system, which improves and/or simplifies the determination of the corresponding energy inflow, energy outflow and/or energy consumption information.

The digital twin can be configured, for example, as a computer program product, or comprise such a product, which simulates, at least inter alia when executing on a computer device, at least inter alia, the installation and/or the heating system and/or the device or component. Furthermore, the digital twin may include further parameters, data, state variables, meta-information, design and configuration information and further information regarding the installation and/or the heating system.

Generally speaking, a digital twin, for example, for a particular installation, refers to a collection of digital information items related to that installation.

The digital twin may comprise, for example, an installation design, an installation plan, installation parameters or comparable information characterizing an installation.

The digital twin may also include information regarding a current state of the installation, for example, current state parameters or physical measurement parameters relating to the installation, operating parameters and/or information relating to an operating state of the installation, or comparable parameters or information.

Furthermore, the digital twin can include a simulation of the installation, which makes it possible to simulate the installation, for example, in real time, or else independently of a corresponding real installation. Here, the simulation may be configured, for example, such that such a simulation of the installation is or can be performed in parallel with the operation of the corresponding real installation such that current state or physical parameters of the real installation are used as input variables for such a simulation. Here, the simulation can at least essentially describe or represent a current operating state or state of the installation.

Here, the simulation can be configured, for example, as a computer program product that generates the corresponding simulation when running on a computer. The above-mentioned further parameters, measurement data and other variables characterizing the installation, can be or are stored, for example, in a database forming part of the digital twin. Plans and the like relating to the installation may also be stored in the context of such a database within the digital twin of the installation.

In an advantageous embodiment, the digital twin and/or the simulation of the installation or the heating system comprises a virtual energy flow sensor, and/or the digital twin and/or the simulation of the installation or heating system is configured to simulate an energy flow.

This embodiment enables a simpler and less complex determination of the thermal efficiency for the heating system, because the desired information is or can be determined directly by the use of the digital twin, or the simulation of the energy flow.

Here, the virtual energy flow sensor can be configured, for example, such that the computer device calculates, for example, in the context of a simulation of the heating system, a physical parameter for an energy flow in one or more specific regions of the heating system and/or within a specific pipe or conduit cross-section in the heating system or the supply system or discharge system. Such a parameter may be, for example, a media flow or a media flow density within a certain region or cross-section of the heating system, for example, together with a corresponding temperature of the heating medium. Such a parameter can also be a direct energy flow through a specific pipe or conduit cross-section or pipe or conduit region, or an energy flow through a specific pipe or conduit cross-section or pipe or conduit region. For example, such an energy flow can be measured in energy per unit time, i.e., in Watts.

The simulation of the energy flow can be configured, for example, such that, in the context of the simulation of the heating system in at least one region, in multiple regions or advantageously in all regions of the simulated heating system, an energy flow can be or is determined by the simulation in accordance with the disclosed embodiments.

For example, if in the context of the simulation of the heating system it is defined in the simulation that at a specific point or a specific cross-section of the simulated heating system the energy flow will be determined or is determined at that point or cross-section, then this definition is designated within the simulation program or within the simulation of the heating system as a “virtual sensor”, in this case a virtual energy-flow sensor.

The system, the installation and/or the heating system can further comprise a control device, where the computer device is configured to transmit the energy inflow information and/or the energy outflow information and/or the energy consumption information to the control device, and where the control device is configured to take into account the energy inflow information and/or the energy outflow information and/or the energy consumption information as part of the control of the installation or the heating system.

This advantageous configuration makes it possible to take the determined energy inflow information, energy outflow information and/or energy consumption information directly into account in the control of the installation and/or the heating system. In this way, it is possible to ensure, for example, that the heating system or even the entire installation is always in a predetermined or predeterminable energy consumption state. As soon as the energy inflow information, energy out flow information and/or energy consumption information ascertained shows that more energy is consumed during the operation of the installation and/or the heating system than specified, it is possible to take appropriate countermeasures using the control system within the context of a control program executed for controlling the installation and/or the heating system.

The control device may be any type of computer or computer system which is configured to control an installation, a device, an apparatus or an appliance. The control device may also be a computer, a computer system or a cloud, upon which control software or a control software application, for example a control application, is implemented or installed. Such a control application implemented in the cloud can be configured, for example, as an application with the functionality of a programmable logic controller or a comparable control device.

The control device can be further configured as an “edge device”, where such an edge device can comprise, for example, an application for controlling devices or installations. For example, such an application can be configured as an application with the functionality of a programmable logic controller or a comparable control system. The edge device may be connected, for example, to a further control device for a device or installation, or also directly to a device or installation to be controlled. Furthermore, the edge device can be configured such that it is additionally connected to a data network or a cloud, or it is configured for connection to a corresponding data network or a corresponding cloud.

The control device may also be configured, for example, as a programmable logic controller (PLC). Furthermore, the control device can also be configured as a modular programmable logic controller (modular PLC).

A modular programmable logic controller may be configured such that multiple modules are or can be provided where, normally, one or more expansion modules can be provided in addition to a central module, which is configured for executing a control program, for example, to control a component, machine or installation (or a part thereof). Such expansion modules may be configured, for example, as a current/voltage supply, for input and/or output of signals, or else as a function module for carrying out specific tasks (e.g., a counter, a converter, a simulation of a controlled system or data processing with artificial intelligence methods).

For example, a function module can also be configured as an AI module for performing actions using artificial intelligence methods. Such a function module can be, for example, a neural network or a machine learning (ML) model.

Furthermore, a function module can also be configured to simulate a system, for example, a connected installation or device. In the present case, the programmable logic controller may comprise, for example, a module that is configured to simulate the controlled installation or the controlled heating system. Here, the computer device in accordance with the present disclosure may be configured, for example, as a function module for a programmable logic control device for controlling the installation and/or the heating system.

A programmable logic controller, or PLC for short, is a component that is programmed and used to regulate or control an installation or machine. In programmable logic controllers, specific functions such as sequence control can be implemented, so that both the input and the output signals of processes or machines can be controlled. The programmable logic controller is defined, for example, in the standard EN 61131.

Connecting a programmable logic controller to the installation or machine requires the use of both actuators, which are generally connected to the outputs of the programmable logic controller, and sensors. Status indicators are also used. Typically, the sensors are located at the PLC inputs, where they provide the programmable logic controller with information about what is occurring in the installation or machine. Examples of sensors are as follows: light barriers, limit switches, pushbuttons, incremental encoders, level sensors, temperature sensors, pressure sensors. The following are examples of actuators: contactors for switching on electric motors, electrical valves for compressed air or hydraulics, drive control modules, motors, drives.

A PLC can be realized in different ways. This means that it can be implemented, for example, as a stand-alone electronic device, as a software emulation, as a plug-in PC card, etc. Modular solutions are often found, in which the PLC is assembled from multiple plug-in modules.

Furthermore, a control device can also be implemented as a virtual control device, soft PLC or virtual PLC (programmable logic controller). Such a virtual control device or soft PLC can consist, for example, of one or more software applications installed on a computer, computer system or a cloud. In such a case, a modular PLC can be realized, for example, such that each module of the modular PLC is realized as a separate software application, which is connected, for example, by a suitable data bus or a suitable data management system, such as a real-time data bus or a real-time data management system.

An installation in accordance with the present disclosure can be configured, for example, as a tire curing press, a brewery or a brewing kettle.

In particular, in the operation of so-called tire curing presses for vulcanizing vehicle tires, or in the context of brewing kettles used in breweries, heated steamers and/or heated water (at least inter alia) are used to provide the heating for the tire curing press or the brewing kettle. Such steam heating systems are often relatively large and extensive and require a relatively large supply of energy. Therefore, a system in accordance with the present disclosure and/or a method in accordance with the present disclosure are particularly advantageous in these cases, because they provide a way to achieve significant energy savings.

A system in accordance with the present disclosure and/or a method in accordance with the present disclosure makes it possible to provide energy consumption information without the need to install separate sensor technology in addition to the sensors already present in the system. Accordingly, applications of a system or method such as these are particularly attractive in the field of tire manufacturing and brewing.

A tire curing press, also referred to as a vulcanizing press or simply “curing press”, is understood to mean a machine or installation that is configured for vulcanizing vehicle tires. This method step in the production of a vehicle tire is a curing process in which the corresponding vehicle tire is given its final shape. During this curing process, the tire is vulcanized for a certain period of time at a certain pressure and temperature. During this process step, the raw rubber is converted into flexible and elastic rubber. In addition, the tire is given its profile and sidewall markings in an appropriate mold of the vulcanizing press or the tire curing press.

Usually, such a vulcanizing press comprises one or two molds, which can each accommodate a so-called tire blank or “green tire”. Such a vulcanizing press usually comprises piping systems for hot gases, liquids or vacuum, and conveyor belts for transporting the tire blanks and the finished vulcanized vehicle tires to and from the press.

In the course of a vulcanization process of a tire blank in such a tire curing press, a heating bladder is inserted into the interior of the tire blank, similar to a bicycle inner tube, and then a hot gas or hot liquid is supplied to this heating bladder under high pressure. In this way, the heating bladder presses the tire blank into the mold (with, for example, the tire profile and markings being imprinted at the same time) and then initiates the vulcanization process of the tire due to the high temperature. After the vulcanization process, the now vulcanized vehicle tire is removed from the mold and forwarded to the next processing step of the tire production.

The heating bellows (also referred to as “bladder” or “tire curing bladder”) is configured as an elastic bladder (made, e.g., of rubber or a comparable material), which can be inflated or expanded via a supply of gas or liquid, and can be deflated by outflow and/or extraction of gas or fluid contained in it. The heating bladder can be configured, for example, such that it expands or can expand when filled with a gas or liquid, and accordingly contracts or can contract again when it is emptied.

The heating bladder can be further configured, for example, such that the gas or liquid that is or can be supplied can exhibit temperatures, example, of up to 100 degrees Celsius, advantageously of up to 200 degrees Celsius and more advantageously of 250 degrees Celsius.

The heating bladder can also be configured such that the gases supplied can include, for example, heated air, heated steam, nitrogen and/or other gases, including at the above-mentioned temperatures. For example, heated water is often used as the liquid.

The heating bladder can be configured such that, at least in the interior of a tire blank, it can withstand a pressure of up to 30 bar or more, or a vacuum pressure of up to −1 bar.

Of particular importance in the monitoring of a vulcanization process in a tire curing press is the monitoring of the heating bladder. For example, cracks and/or leaks in the material of the bladder can allow hot gas or hot liquid to enter the space between the bladder and the tire blank and cause the newly produced vehicle tire to be defective. If such a crack or defect in the heating bladder is detected too late, for example, then this can cause a larger amount of unusable vehicle tires to be produced in the tire curing press.

Therefore, it is advantageous to detect such damage in a heating bladder at an early stage or, better still, to detect that such damage will occur in the near future, even before the actual defect occurs. This can be achieved, for example, by detecting the associated precursors of such a defect, for example, micro-cracks, in advance. Such leaks and micro-cracks in a heating bladder can be detected, for example, from an increasing energy consumption of an associated heating system for the heating bladder. Here, a system or method in accordance with the present disclosure can provide a way to detect such an increasing energy consumption in the heating system which is simpler, more effective or less expensive in comparison to the prior art.

The above-stated objects and advantages in accordance with the invention are also achieved by a method for determining the energy consumption of an installation in accordance with the disclosed embodiments having a heating system in accordance with the disclosed embodiments, comprising the steps of:
transmitting data from the at least one supply system sensor and/or the at least one discharge system sensor to the computer device,
simulating an energy inflow generated by an inflow of the heated medium to the device or component, and/or simulating an energy outflow generated by an outflow of the medium from the device or component, and
ascertaining the energy inflow information and/or the energy outflow information and/or the energy consumption information.

Here, the heating system, the at least one supply system sensor, the at least one discharge system sensor, the computer device, the simulation, the acquisition of the energy inflow information, the energy outflow information and/or the energy consumption information, can be configured in accordance with the disclosed embodiments.

Furthermore, the simulation of the energy inflow generated by supplying the heated medium to the device or component, as well as the simulation of the energy outflow generated by an outflow of the medium from the device or component, can be configured in accordance with the disclosed embodiments.

The method may be further configured such that the energy inflow information and/or the energy outflow information and/or the energy consumption information is transmitted to a control device for the installation and/or the heating system to influence the control of the installation or the heating system.

Here, the energy inflow information and/or the energy outflow information and/or the energy consumption information can be transmitted to the control device for the installation and/or the heating system in order to influence the control of the installation or heating system in accordance with the disclosed embodiments.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Hereafter, the present invention is explained in more detail based on examples and with reference to the attached figures, in which:

FIG. 1 shows a schematic representation of a steam heating system for a tire curing press and an associated control device in accordance with the invention;

FIG. 2 shows a schematic representation of a simulation model for the steam heating system of FIG. 1; and

FIG. 3 is a flowchart of the method in accordance with the invention.

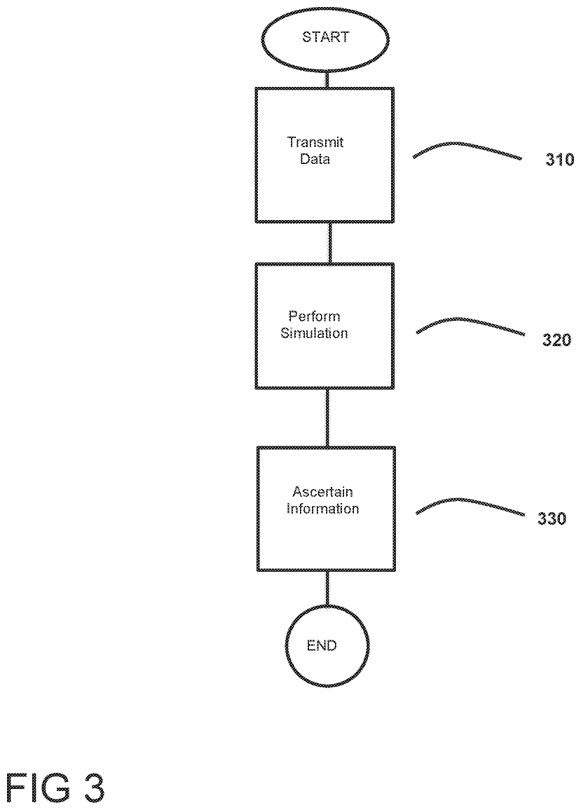

### DETAILED DESCRIPTION OF THE EXEMPLARY EMBODIMENTS

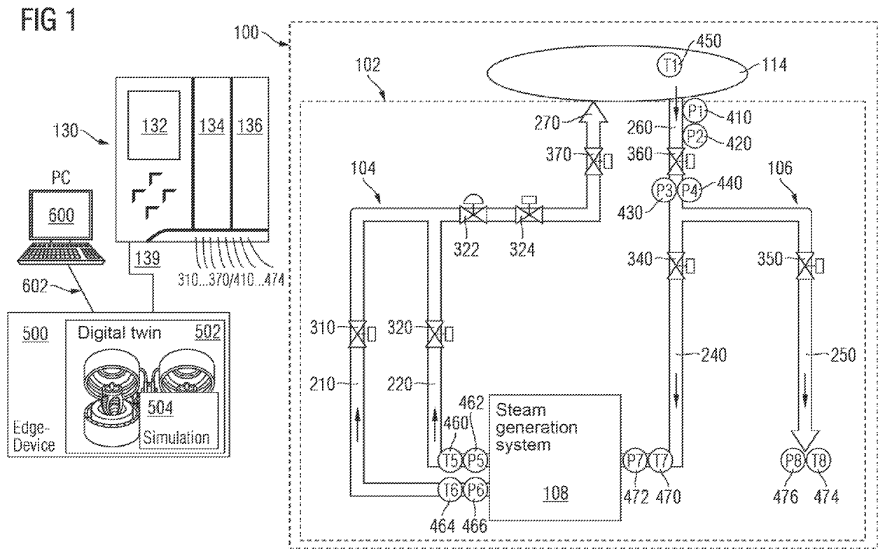

FIG. 1 shows an exemplary embodiment of a heating system 102 in accordance with the present disclosure or an installation 100 in accordance with the present disclosure, using the example of a steam heater 102 for a tire curing press device 100 or tire curing press 100 in accordance with the present disclosure.

The tire curing press 100 comprises a vulcanizing station for vulcanizing a tire blank (not shown in FIG. 1).

For the purpose of vulcanizing tire blanks, the tire curing press 100 comprises a lower and an upper tire mold, which surround the tire blank during the vulcanizing process. These can be heated up via a heating system using hot steam. For the sake of simplicity, the upper and lower tire molds, the tire blank and the heating system for the tire molds are not shown in FIG. 1.

To support the vulcanization of the tire blank, the tire curing press 100 further comprises a heating bladder 114, which is shown schematically in FIG. 1. In the course of the vulcanizing process of the tire blank, the heating bladder 114 is filled with hot steam under high pressure, expands inside the respective tire blank, thereby pressing it against the lower or upper tire mold. In this way, in addition to the actual vulcanization of the tire material, for example, a tire profile and other relief-like structures of the vehicle tire are also impressed into the tire blank.

The hot steam mentioned above for filling and heating the heating bladder 114 is only one example of the wide variety of gases and liquids that can be used in these tire curing presses 100. These can exhibit temperatures, for example, of up to 100 degrees Celsius, advantageously of up to 200 degrees Celsius and further advantageously up to 250 or 300 degrees Celsius during the vulcanization process.

The heating bladder 114 and the corresponding media system 102 can be furthermore configured such that the gases supplied can include, for example, air, steam, nitrogen and/or other gases, including at the above-mentioned temperatures. If, for example, liquid media are to be used instead, then heated water is often used.

The heating bladder 114 can be configured such that, at least in the interior of a tire blank, it can withstand a pressure of up to 30 bar or more, or a vacuum pressure of up to −1 bar.

FIG. 1 also shows the steam media system 102 for filling and emptying the heating bladder 114 with hot steam and/or other heated gases or liquids. For example, this media system 102 can also be configured for the above-mentioned pressure and temperature ranges.

Here, the tire curing press 100 is an exemplary embodiment of an installation in accordance with the present disclosure and the steam media system 102 is an exemplary embodiment of a heating system in accordance with the present disclosure.

Here, a temperature sensor 450 is mounted in the region of the heating bladder 114, with which the temperature of the heating bladder 114 and/or the temperature inside the heating bladder 114 can be ascertained. At the output region of the heating bladder, on the right-hand side of the media system 102, is a first pressure sensor 410 which is structured for measuring a pressure between 0 and 4 bar. Furthermore, a second pressure sensor 420 is also located there, which is structured for measuring a pressure between −1 and 32 bar. With the two pressure sensors 410, 420 and the temperature sensor 450, the state of the steam in the heating bladder 114 in the different pressure and temperature ranges can be determined with good accuracy.

The right-hand portion of the steam media system 102 is configured as a supply region 104 for steam. Here, the supply region 104 according to FIG. 1 is an exemplary embodiment of a supply system in accordance with the present disclosure. In the supply region 104 on the far left is a first inflow line 210 for the inflow of steam at a relatively low pressure between 2 and 8 bar and temperatures of 110 to 180° C. To control the inflow in this first inflow line 210, an on-off valve 310 is provided in this inflow line 210.

In FIG. 1, to the right of this first inflow line 210, a second inflow line 220 is provided for the inflow of steam at high pressure between 17 and 30 bar and at a temperature of between 190 and 230° C. This second inflow line 220 is also part of the supply region 104. In this second inflow line 220, again there is an on-off valve 320 for switching this steam flow on and off. After these two inflow lines 210, 220 merge, a control valve 322 is provided in the merged supply line, with which the respective steam flow can be more precisely controlled. A safety valve 321 is arranged downstream in the inflow line.

Both the supply lines 210, 220 then run together in a single heating bladder supply 270, in which a main inlet valve 370 is provided. The heating bladder supply 270 is also part of the supply region 104.

On the outlet side of the heating bladder, a main outlet line 260 is provided for discharging liquids or gases contained in the heating bladder 114. In this outlet line 260, the above-mentioned pressure sensors 410, 420 are also located. Downstream of these pressure sensors in the outlet direction is a main outlet valve 360 for controlling the media outlet from the heating bladder 114. Downstream of the outlet valve 360 in the outlet line 260, a third pressure sensor 430 is again located for detecting media in a pressure range between 0 and 4 bar and a fourth pressure sensor 440 for measuring the pressure of media in a pressure range between −1 and 32 bar. Downstream of the main outlet line 260 is a further outlet line 240 with an on-off valve 340. This main outlet line 240 is fed back to a steam generation system 108, where at the end of the main outlet line 240 at the input to the steam generation system 108 a maximum pressure of 0.2 bar and a maximum temperature of 60° C. are present when the heating system 102 is operating.

After the main outlet line 260, issuing from the outlet line 240, a vacuum line 250 with an on-off valve 350 is provided, via which, for example, gases or liquids contained in the heating bladder 114 can be actively extracted by suction. Here, the suction line 450 or a pump mounted behind it (not shown in FIG. 1) can be used, for example, to build up a negative pressure or vacuum in the range from −0.5 to −0.1 bar and a maximum temperature of the media of 60° C. To measure the pressure prevailing at the end of the suction line 450 and the temperature there, a pressure sensor 476 and a temperature sensor 474 are mounted there.

Here, the main outlet line 260, the outlet line 240 and the vacuum line 250 are part of a discharge region 106, for discharging the heating medium from the heating bladder 114. Here, the discharge region 106 is an exemplary embodiment of a discharge system in accordance with the present disclosure.

The steam media system 102 further comprises a steam generation system 108 for heating the steam and feeding the heated steam under the appropriate applied pressure into the supply lines 210, 220 of the supply region 104. A temperature sensor 464 and a pressure sensor 466 are provided on the first inflow line to measure the input temperature and the input pressure of the steam fed into the first supply line by the steam generation system. Furthermore, a temperature sensor 460 and a pressure sensor 462 are provided on the second inflow line to measure the input temperature and the input pressure of the steam fed into the second supply line by the steam generation system.

Furthermore, at least a portion of the steam discharged from the heating bladder 114 is fed back into the steam generation system 108 via the outlet line 240, in order to be reheated there and then fed back to the supply region 104. A temperature sensor 470 and a pressure sensor 472 are mounted at the corresponding input of the steam generation system 108 to measure the temperature and pressure there.

The steam generation system 108 in the present exemplary embodiment is considered to belong to both the supply region 104 and the discharge region 106 of the steam media system 102.

Furthermore, FIG. 1 shows a control device 130, which is configured as a modular control device 130 with a central module 132 and a first input-output module 134 and a second input-output module 136.

Here, corresponding signal output lines are routed from the input-output modules 134, 136 to the various valves 310, 320, 322, 321, 330, 335, 370, 360, 340, 350 of the media system 102. These signal output lines allow control signals to be transmitted from the central module 132 of the control device 130 to the above-mentioned valves 310, 320, 322, 321, 330, 335, 370, 360, 340, 350, in order to adjust the corresponding valve positions.

In addition, corresponding signal input lines are routed from the temperature sensors 450, 460, 464, 470, 474 and the pressure sensors 410, 420, 430, 440, 462, 466, 472, 476 to the input-output modules 134, 136, in order to transmit the corresponding sensor values to the central module 132 of the control device 130.

This is symbolized in FIG. 1 by listing the reference signs of the corresponding valves and sensors below the output and input lines shown symbolically below the controller 130.

A processing environment for a corresponding control program for controlling the tire curing press 100 is provided in the central module 132. For vulcanizing a tire blank inserted in the right-hand part of the tire curing press 100, a gas inflow and gas outflow can then be controlled via the incoming sensor signals and the outgoing actuating signals for corresponding valves 310, 320, 322, 324, 330, 335, 370, 360, 340, 350, for example, as part of the execution of this control program, to provide the proper support for the vulcanization process. In this way, a suitable support for the vulcanizing process of the tire blank 116 is achieved by a corresponding inflow and outflow of heated steam into and out of the heating bladder 114.

FIG. 1 additionally shows an edge device 500. The edge device 500 comprises a digital twin 502 of the tire curing press 100, which in turn comprises, inter alia, a simulation 504 of the steam media system 102 together with the heating bladder 114. Here, the edge device 500 is an exemplary embodiment of a computer device in accordance with the present disclosure, and the digital twin and the simulation respectively are exemplary embodiments of a digital twin or a simulation in accordance with the present disclosure, respectively.

This edge device 500 is connected to the control device 130 via a field-bus line 139. For example, control commands that are used to control the tire curing press 100 can be transmitted to the evaluation device via this field-bus line. Furthermore, position information of the valves 310, 320, 322, 324, 330, 335, 370, 360, 340, 350 of the media system 102 can be transmitted to the edge device 500 via the field-bus line 139. This field-bus line can also be used by the control device to transmit measured values of the temperature sensors 450, 460, 464, 470, 474 and the pressure sensors 410, 420, 430, 440, 462, 466, 472, 476 to the edge device.

The control device 130 and the simulation 504 of the heating system 102 with the heating bladder 114 are configured such that the above-mentioned valve position information and sensor values are transmitted from the control device to the edge device via the field-bus line 139 at regular intervals (e.g. 1x per program cycle of a control program, once per tenth of a second, once per second, once per minute, . . . ). Then, within the simulation 504, a steam flow in the supply region 104 and discharge region 106 of the steam media system 102 is simulated based on pressure and temperature values in the input lines 210, 220 and the output lines 240, 250.

In an advantageous embodiment of the simulation, the simulation also takes the pressure in the heating bladder as input, which is supplied by the associated pressure sensors 410, 420 positioned directly at the output of the heating bladder 114.

Furthermore, pressure values from the pressure sensors 430, 440 in the discharge region 106 of the heating system 102 can also be used for the simulation.

As a rule, a simulation of the heating system 102 will improve, or the simulation results will correspond better to the actual conditions in the heating system 102, the more sensor values from the real heating system 102 are used as input variables for the simulation 504.

As part of the control of the media system 102 with the control device 130, during the production of vehicle tires position values of the valves 310, 320, 322, 324, 330, 335, 370, 360, 340, 350 of the media system 102 and the sensors 450, 460, 464, 470, 474, 410, 420, 430, 440, 462, 466, 472, 476 of the media system 102 are then regularly/continuously transmitted to the edge device 500 where they are input into the simulation 504 as input variables as described above.

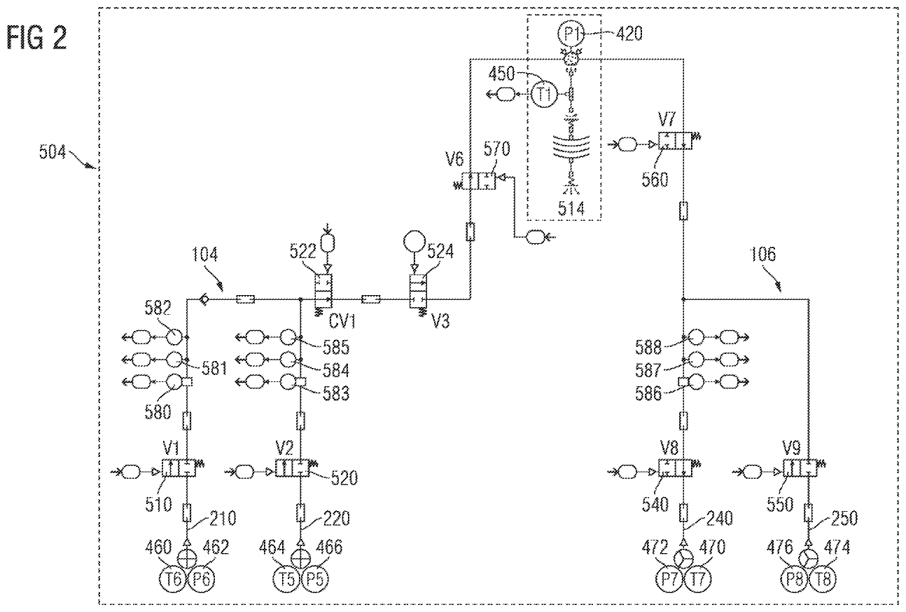

The simulation 504 is configured in such a way, via soft sensors 580, 581, 582, 583, 584, 585, 586, 587, 588 (see FIG. 2) to ascertain and output state parameters of the steam in the supply region 104 and the discharge region 106. Such state parameters are, for example, a temperature, a pressure and an energy flow. This is explained in greater detail in conjunction with FIG. 2.

The edge device 500 is further configured so as to ascertain an energy consumption or energy loss during the heating of the heating bladder 114 from the energy inflows determined by the simulation in the inflow region 104 and the energy discharges determined by the simulation in the discharge region 106. This can be performed, for example, by calculating a difference between the supplied energy flow and the discharged energy flow or a difference between the amount of energy supplied over a certain period and the amount of energy discharged over a certain period.

This information is ascertained, for example, in a cycle of the data supplied and transmitted, for example, to an HMI system 600 via an Open Platform Communications Unified Architecture (OPC-UA) communication link 602, in order to output it to an installation operator for monitoring purposes. Furthermore, the energy consumption information is transmitted back to the control device 130 in order to respond, for example, to an increasing energy consumption in the control of the steam media system 102 and, for example, to adjust the control of the valves 310, 320, 322, 324, 330, 335, 370, 360, 340, 350 accordingly, to reduce the energy consumption of the steam heater of the heating bladder 114 back to a predetermined or predeterminable consumption value.

FIG. 2 shows a simulation model 504, which comprises a simulation model of the heating system 102 shown in FIG. 1 together with a simulation model 514 of the heating bladder 114 also shown in FIG. 1.

The simulation model 504 contains an image of the supply region 104 of the heating system 102 with the two inflow lines 210, 220 and simulations 510, 520 of the on-off valves 310, 320 of the real heating system 102 contained in the inflow lines 210, 220. Furthermore, the simulation model 504 in the supply region 104 also contains a simulation of the control valve 522 and the safety valve 521, along with a simulation of the main inlet valve 570.

As input values of the steam in the left-hand, first inflow line 210, the values determined by the temperature sensor 464 and pressure sensor 466 in the real inflow line 210 of the real heating system 102 are used, which is indicated symbolically according to the simulation model 504. Accordingly, the values of the temperature sensor 460 and the pressure sensor 462 from the real heating system 220 are used as input values for the incoming hot steam for the right-hand inflow line 102. This is also indicated symbolically in FIG. 2.

In the simulation 504, the corresponding connecting pipes or supply pipes of the supply region 104 are assigned corresponding length and cross-sectional information in order to be able to calculate the corresponding flow rates and pressure conditions in a realistic manner in the simulation.

The simulation model also comprises a simulation of the heating bladder 514 including a simulation of its corresponding thermal properties. The input variables used as the basis for the simulation 504 of the heating bladder 514 are the pressure measured in the real heating bladder 114 and supplied by the corresponding pressure sensor 420, as well as the temperature measured by the temperature sensor 450 in the heating bladder.

The simulation model 504 also contains an image of the discharge region 106 with a simulation 560 of the real main outlet valve 360 according to FIG. 1 and models of the two outlet lines 260, 250 with simulation of the corresponding on-off valves 540, 550 in each case.

As the input value for the simulation model 504, the values of the pressure sensor 472 and temperature sensor 470 in the left outlet line 240 and the values of the pressure sensor 476 and temperature sensor 474 in the right outlet line 250 are again used, which is also indicated symbolically in FIG. 2.

Furthermore, the simulation model comprises 504 virtual energy flow and/or power sensors 580, 583, 586. These virtual energy flow sensors 580, 583, 586 each provide an energy flow value or power value for the steam energy flowing through the corresponding pipe cross-section at the point shown in FIG. 2, based on the simulation of the steam flow at this point. This can be determined via the simulation, for example, based on a steam temperature calculated at this point as part of the simulation, a corresponding specific thermal capacity of the steam and a flow velocity of the steam passing through this pipe cross-section.

In a similar manner, the simulation model 504 also comprises three virtual temperature sensors 581, 584, 587, which output a steam temperature ascertained at this point of the supply region 104 and discharge region 106 respectively as their output values. Furthermore, the simulation model similarly also comprises three virtual pressure sensors 582, 585, 588, which each output the pressure of the steam calculated in the simulation at the respective positions in the supply region 104 and discharge region 106 as output values.

Furthermore, the digital twin 502 (see FIG. 1), or the simulation 504 within the digital twin 502, can be configured, for example, such that a total energy inflow value, which is formed by the sum of the virtual energy flow sensor 580 in the left-hand inflow line 210 and the virtual energy flow sensor 583 in the right-hand inflow line 220, is output to the HMI 600. In addition, the value of the virtual energy flow sensor 586 in the left-hand outlet line 240 can also be output to the HMI 600 as the energy discharge.

In a further advantageous embodiment, the difference of the energy inflow according to the above description minus the energy outflow in accordance with the above description can also be output to the HMI 600 as energy consumption information.

The energy inflow value, the energy outflow value and the energy consumption value explained above are examples of energy inflow information, energy outflow information and energy consumption information in accordance with the present disclosure.

This information may include, for example, additional information, for example, a date and time of determination of these values, an identifier for an installation to which these values can be or are assigned, an identifier or ID or even a file name of the simulation model by means of which these values were obtained, temperature, pressure and comparable input parameters for the simulation. Furthermore, the information mentioned may also include information about a product produced in the real installation in parallel with the simulated process, or a corresponding product identifier. In this way, for example, a manufactured product can be assigned an energy consumption value ascertained during its vulcanization process.

Furthermore, the edge device 500 or the digital twin 502 in the edge device 500 can be configured such that the ascertained energy outflow, energy inflow and/or energy consumption values are transmitted via the field-bus line 139 back to the control device 130 where they are used as input data for a control program for controlling the tire curing press 100 and/or the heating system 102 for the tire curing press 100. Here, the control program can be configured such that a specific default range is predetermined for the energy consumption of the heating system 102 when heating the heating bladder 114 and the control of the heating system is configured such that the energy consumption of the tire curing press 100 remains in this default range. By transmitting back an energy consumption value obtained from the virtual sensors 580, 581, 582, 583, 584, 585, 586, 587, 588 in the simulation 504 during the steam heating of the heating bladder 114, the heating system 102 can then be regulated such that the energy consumption permanently remains in this default range.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-8. (canceled)

9. A system having an installation, the installation comprising:
a heating system; and
a device or component;
wherein the system is configured to heat the device or component via a heated medium transported within the heating system;
wherein the heating system comprises a supply system within which the heated medium is supplied to the device or component;
wherein the supply system comprises at least one supply system sensor;
wherein the heating system further comprises a discharge system within which the medium is discharged from the device or component;
wherein the discharge system comprises at least one discharge system sensor;
wherein the system further comprises a computer device which is configured to simulate the heating system using data from at least one of the at least one supply system sensor and the at least one discharge system sensor,
wherein the computer device is configured to ascertain at least one of (i) energy inflow information, (ii) energy outflow information and (iii) energy consumption information.

10. The system as claimed in claim 9, wherein the at least one supply system sensor comprises at least one of (i) a supply temperature sensor and (ii) a supply pressure sensor, and the at least one discharge system sensor comprises a discharge pressure sensor;
wherein the computer device is configured to ascertain at least one of (i) the energy inflow information, (ii) the energy outflow information and (iii) the energy consumption information utilizing at least one of data of the supply temperature sensor, the supply pressure sensor and the discharge pressure sensor.

11. The system as claimed in claim 9, wherein the computer device at least one of (i) comprises a digital twin of the installation or the heating system and (ii) is configured to simulate the installation or the heating system.

12. The system as claimed in claim 10, wherein the computer device at least one of (i) comprises a digital twin of the installation or the heating system and (ii) is configured to simulate the installation or the heating system.

13. The system as claimed in claim 11, wherein at least one of (i) the digital twin and (ii) the simulation of the installation or the heating system comprises a virtual energy flow sensor; and
wherein at least one of the digital twin and the simulation of the installation or the heating system is configured to simulate an energy flow.

14. The system as claimed in claim 9, wherein at least one of (i) the system, (ii) the installation and (iii) the heating system comprises a control device, and the computer device is configured to transmit at least one of the energy inflow information, the energy outflow information and the energy consumption information to the control device; and
wherein the control device is configured to take into account at least one of (i) the energy inflow information, (ii) the energy outflow information and (iii) the energy consumption information during the control of the installation or the heating system.

15. The system as claimed in claim 9, wherein the installation is configured as a tire curing press, a brewery or a brewing kettle.

16. The system as claimed in claim 9, wherein the heated medium comprises heated water or steam.

17. A method for determining energy consumption of an installation having a heating system, the method comprising:
transmitting data from at least one of (i) at least one supply system sensor and (ii) at least one discharge system sensor to a computer device;
performing at least one of a simulation of an energy inflow generated by an inflow of a heated medium to the device or component and a simulation of an energy outflow generated by an outflow of the medium from the device or component; and
ascertaining at least one of (i) energy inflow information, (ii) energy outflow information and (ii) energy consumption information.

18. The method as claimed in claim 17, wherein at least one of (i) the energy inflow information, (ii) the energy outflow information and (iii) the energy consumption information is transmitted to a control device for at least one of the installation and the heating system to influence the control of the installation or the heating system.
